(19) United States
(12) Patent Application Publication
(10) Pub. No.: US 2026/0226801 A1
(43) Pub. Date: Aug. 6, 2026

(54) THREAD PROFILE FOR THREADED CONNECTION

(71) Applicant: TENARIS CONNECTIONS B.V., Amsterdam (NL)

(72) Inventor: Jorge Alberto Cordero Torres, Amsterdam (NL)

(73) Assignee: TENARIS CONNECTIONS B.V., Amsterdam (NL)

(21) Appl. No.: 19/157,534

(22) PCT Filed: Feb. 15, 2024
(86) PCT No.: PCT/EP2024/053923

§ 371 Date: Aug. 18, 2025

(30) Foreign Application Priority Data
Feb. 23, 2023 (NL) 2034218

(51) Int. Cl. E21B 17/042; F16L 15/00

(52) U.S. Cl. CPC E21B 17/042; F16L 15/001

(57) ABSTRACT

Thread profile for a pin and a box of a threaded connection for exploration and production of a hydrocarbon well, comprising at least one helically extending thread turn for said pin, and at least one helically extending thread turn for said box. The thread turns have a stab flank with a stab flank height, a load flank with a load flank height, and a crest. The stab flank comprises a stab flank collision surface adjoining the stab flank with the crest. The stab flank collision surface has a first stab flank radius. The thread turns comply with:

$$LFH < SFH , and \qquad ( 1 )$$

$$0.2 \leq \frac{{SFR}_{1}}{SFH} \leq 0.4 , \qquad ( 2 )$$

wherein SFR₁ is the first stab flank radius, SFH is the stab flank height, and LFH is the load flank height.

The present invention relates to a thread profile for a threaded connection for the exploration and production of a hydrocarbon well, a threaded connection comprising said thread profile, a pin and a box for said threaded connection, and a method of forming said threaded connection.

A threaded connection for the exploration and production of a hydrocarbon well generally comprises a pin provided at the free end of a first tubular member, and a box provided at the free end of a second tubular member. The pin comprises at the outer surface thereof a male tapered thread, and the box comprises at an inner surface thereof a female tapered thread.

The male tapered thread and the female tapered thread extend helically along, respectively, the outer surface of the pin of the first tubular member, and the inner surface of the box of the second tubular member, wherein the male tapered thread and female tapered thread correspond with each other to facilitate threaded engagement of the first tubular member with the second tubular member.

To form (or make-up) the threaded connection, the pin is, in a first stage of make-up, inserted (or stabbed) into the box, after which, in a second stage of make-up, the pin is rotated, in a make-up direction, with respect to the box, wherein the male tapered thread engages the female tapered thread.

For operational purposes, it is beneficial if the thread profile of the threaded connection is arranged such to allow deep stabbing of the pin into the box. This way, it is possible to have part of the male thread pass part of the female thread in axial direction, before commencing the second stage of make-up. The more thread turns pass each other in the first stage of make-up, the fewer rotational turns are required to reach the end of the second stage of make-up. As such, with deeper stabbing, it is possible to reduce the time required to make-up the connection, and therewith reduce operational costs.

It is known to enable deeper stabbing by providing the pin and the box with a relatively steep male tapered thread, and steep female tapered thread, respectively. This way of allowing deeper stabbing is, however, disadvantageous, because a steeper taper generally requires a tubular member with a larger wall thickness. As such, a steeper taper generally comes with concessions to the inner diameter and/or the outer diameter of the threaded connection.

Also, in the second stage of make-up, rotating the pin with respect to the box to reach the final make-up position may lead to damage to the threads. This damage may, for instance, occur when the first tubular member is not properly axially aligned with the second tubular member. In particular, misalignment of the first tubular member with respect to the second tubular member may lead to so-called “cross-threading”, and/or thread parts coming into contact with each other wherein high contact pressures arise while the tubulars are being rotated. The latter may lead to galling at the threads.

Attempts have been made to reduce the risk of damage to the threads of the connection.

US2021364119 AA discloses a threaded connection for pipes having misalignment resistance and high torque on shoulder resistance. The threaded connection comprises a pin and a box. The pin and box include contact surfaces having threaded portions and unthreaded metal contact portions. On at least one of the contact surfaces there is provided a particular surface roughness, a Zn—Ni alloy plating layer, a Cu—Sn—Zn alloy plating layer, and a solid lubricant coating layer.

It is an object of the present invention to provide an improved, or at least alternative, thread profile suitable for a threaded connection for the exploration and production of a hydrocarbon well. In particular, it is an object of the present invention to provide a thread profile that may help to reduce operational costs and the risk of damage to the threads of the connection. More in particular, it is an object of the present invention to provide a thread profile that allows relatively deep stabbing, while at the same time limiting the risk of galling.

The object is achieved in a first aspect of the present invention with a thread profile for a pin and a box of a threaded connection for exploration and production of a hydrocarbon well, comprising at least one helically extending thread turn for said pin, and at least one helically extending thread turn for said box, said thread turns having a stab flank with a stab flank height, a load flank with a load flank height, and a crest, wherein:
said stab flank comprises a stab flank collision surface adjoining the stab flank with the crest;
said stab flank collision surface has a first stab flank radius; and
said thread turns comply with:

$$LFH < SFH , and \qquad ( 1 )$$

$$0.2 \leq \frac{{SFR}_{1}}{SFH} \leq 0.4 , \qquad ( 2 )$$

wherein SFR₁ is the first stab flank radius, SFH is the stab flank height, and LFH is the load flank height.

By providing a thread profile for a threaded connection in accordance with the present invention, it is possible to have the connection perform well in the first stage, as well as in the second stage of make-up. In particular, the present invention allows for good stab-ability, as well as a reduced risk of damage, in particular due to galling, to the threads of the connection.

In particular, a load flank height that is smaller than a stab flank height, and a ratio of the first stab flank radius to the stab flank height of 20% to 40%, enables, in the first stage of make-up, to form a first contact angle at the stab flank collision surfaces, wherein the pin is inclined to move with respect to the box in axial direction. The same configuration helps, in the second stage of make-up, to form a second contact angle at the stab flank collision surfaces, wherein, upon rotational movement to make-up the threaded connection, the stab flank collision surfaces slide along each other in radial and helical direction relatively easily. In particular, with the present invention the sliding distance (i.e. the distance the threads need to slide against each other from the start of the second stage to the final make-up position) is relatively short, while at the same time contact pressures may be evenly distributed over the stab flank collision surfaces. As such, the risk of galling at these surfaces may be reduced.

In addition, it was an insight of the inventors, that the thread configuration of the present invention tends to axially align the pin with respect to the box at an early stage, namely in the first stage of make-up, wherein the tubular members are more likely to be axially aligned with each other before the second stage of make-up begins. As such, the risk of cross-threading and/or high contact pressures may be even further reduced.

Generally, a “tubular member” is a (substantially) cylindrical hollow body with a longitudinal axis. Typically, such tubular member is made of a steel. The tubular member comprises a cylindrical wall having a wall thickness. The cylindrical wall defines an inner wall surface, and an outer wall surface.

The tubular member comprises at a first axial end thereof a first pin or a first box, and, at a second axial end opposite the first axial end, a second pin or a second box. Often, the pin or box at the first axial end corresponds with the pin or box at the second axial end. In particular, the tubular member may comprise at the first axial end a pin, and at the second axial end a corresponding box.

The pin comprises a male thread. The male thread is provided at the outer surface of the pin. The male thread is tapered so as to reduce in outer diameter towards the free end of the pin.

The box comprises a female thread. The female thread is provided at the inner surface of the box. The female thread is tapered so as to increase in inner diameter towards the free end of the box.

The male tapered thread extends helically along the outer surface of the pin. The male tapered thread comprises a male root, a male crest, a male load flank, and a male stab flank. The male root may have a rectilinear surface. The male root extends along a male root taper angle with respect to the longitudinal axis of the pin. The male root taper may have a single male root taper angle. As such, the male root may extend along a (single or constant) conical male root generatrix. The male crest extends along a male crest taper angle with respect to the longitudinal axis of the pin. The male crest taper may have a single male crest taper angle. As such, the male crest may extend along a (single or constant) conical male crest generatrix. In particular, the conical male root generatrix and the conical male crest generatrix may extend in the same direction or parallel to each other. The conical male root generatrix is closer to the longitudinal axis of the pin than the conical male crest generatrix.

The male stab flank faces towards the free end of the pin. The male load flank faces away from the free end of the pin.

The female tapered thread extends helically along the inner surface of the box. The female tapered thread comprises a female root, a female crest, a female load flank, and a female stab flank. The female root may have a rectilinear surface. The female root extends along a female root taper angle with respect to the longitudinal axis of the box. The female root taper may have a single female root taper angle. As such, the female root may extend along a (single or constant) conical female root generatrix. The female crest extends along a female crest taper angle with respect to the longitudinal axis of the box. The female crest taper may have a single female crest taper angle. As such, the female crest may extend along a (single or constant) conical female crest generatrix. In particular, the conical female root generatrix and the conical female crest generatrix may extend in the same direction or parallel to each other. The conical female root generatrix is further away from the longitudinal axis of the box than the conical female crest generatrix.

Points for forming a surface of a root generatrix may be taken per thread turn, at the root, in the middle of an axial distance between facing load and stab flank. Points for forming a surface of a crest generatrix may be taken per thread turn, at the crest, in the middle of an axial distance between the load flank facing away from the stab flank.

The female stab flank faces towards the free end of the box. The female load flank faces away from the free end of the box.

The male tapered thread of a pin, and the female tapered thread of a box, each comprise a plurality of thread turns.

The thread profile of the present invention comprises at least one thread turn for a pin, and at least one (corresponding) thread turn for a box. As is convention in the art, a “thread turn” may refer to a turn of a thread extending 360 degrees along the circumference of the pin, or the box. That said, the thread profile of the present invention may comprise more than one (i.e. a plurality of) helically extending thread turns for a pin, and more than one (i.e. a plurality of) helically extending thread turns for a box. As such, the thread turns for the pin may together form a (first) helical length of thread for the pin, and the thread turns for the box may together form a (second) helical length of thread for the box. The helical length of thread for the pin can be part of an entire (uninterrupted) thread, or form an entire (uninterrupted) thread, for the pin. Likewise, the helical length of thread for the box can be part of an entire (uninterrupted) thread, or form an entire (uninterrupted) thread, for the box.

Said helical length of thread for the pin, and, respectively, for the box, may comprise a plurality of secondary thread turns. In such case, the helically extending thread turns having the stab flank collision surface with the first stab flank radius are referred to as “primary helically extending thread turns”, or “primary thread turns”. In this regard, it should be understood, that the secondary thread turns may have different features than the primary thread turns. In particular, the secondary thread turns can have a stab flank without a stab flank collision surface, and/or have a stab flank radius that is different from the first stab flank radius of the primary thread turns.

With a “corresponding helically extending thread turn” may be meant a thread turn for a box configured for colliding, in the first stage of make-up, with a helically extending thread turn for the pin, and for rotationally engaging, in the second stage of make-up, a helically extending thread turn for the pin.

The stab flanks of the present invention comprise a stab flank collision surface. In particular, the male stab flank may comprise a male stab flank collision surface, and the female stab flank may comprise a female stab flank collision surface.

The male stab flank may comprise a male stab flank collision surface, a central male stab flank surface, and an internal male stab flank surface. The male stab flank collision surface adjoins (or connects) the central male stab flank surface with the male crest. The internal male stab flank surface adjoins (or connects) the central male stab flank surface with the male root.

The female stab flank may comprise a female stab flank collision surface, a central female stab flank surface, and an internal female stab flank surface. The female stab flank collision surface adjoins (or connects) the central female stab flank surface with the female crest. The internal female stab flank surface adjoins (or connects) the central female stab flank surface with the female root.

Both the male and female stab flank collision surfaces may have a convex cross section with a first stab flank radius, in particular, when seen from a tangential direction with respect to the longitudinal axis of the pin and/or the box. More in particular, the stab flank collision surfaces are convex in cross section. With a “convex cross section” may be meant, that in cross section the flank surface is rounded outward, e.g. such as the exterior of a circle. On the contrary, the internal male stab flank surface and the internal female stab flank surface may have a concave cross section with a second stab flank radius, in particular, when seen from a tangential direction with respect to the longitudinal axis of the pin and/or the box. More in particular, the internal stab flank surface is concave in cross section. With a “concave cross section” may be meant, that in cross section the flank surface is rounded inward, e.g. such as the inside of a bowl.

The stab flank collision surface may follow a circular arc. In particular, the stab flank collision surface may follow a circular arc starting at the central stab flank surface and ending at the crest. Similarly, the internal stab flank surface may follow a circular arc. In particular, the internal stab flank surface may follow a circular arc starting at the central stab flank surface and ending at the root.

The central (male and/or female) stab flank surface may comprise, in particular, when seen from a tangential direction with respect to the longitudinal axis of the pin and/or box, a linear surface, or may be rectilinear. More in particular, the central stab flank surface starts where the stab flank changes from the curved surface of the stab flank collision surface to a linear surface, and the central stab flank surface ends where the stab flank changes from the linear surface of the central stab flank surface to the curved surface of the internal stab flank surface. The central male stab flank surface, and the central female stab flank surface may extend under an angle of 2-9 degrees, in particular, 5 degrees, with respect to a plane perpendicular to the longitudinal axis of the pin, and box, respectively. A relatively large central stab flank surface may provide improved compression resistance, while the benefits relating to the first and second stage are maintained.

The stab flank has a (total) stab flank height. As such, the male stab flank may have a (total) male stab flank height, and the female stab flank may have a (total) female stab flank height. The stab flank height is equal to the radial distance between the crest and the root adjacent the stab flank. The stab flank height may be measured closer to the stab flank than to the load flank. In particular, the stab flank height may be defined by the stab flank collision surface, the central stab flank surface, and the internal stab flank surface.

The load flanks of the present invention may comprise an external load flank surface, a central load flank surface, and an internal load flank surface. In particular, the male load flank may comprise an external male load flank surface, a central male load flank surface, and an internal male load flank surface, and the female load flank may comprise an external female load flank surface, a central female load flank surface, and an internal female load flank surface.

The external male load flank surface adjoins (or connects) the central male load flank surface with the male crest. The internal male load flank surface adjoins (or connects) the central male load flank surface with the male root.

The external female load flank surface adjoins (or connects) the central female load flank surface with the female crest. The internal female load flank surface adjoins (or connects) the central female load flank surface with the female root.

Both the external male load flank surface and the external female load flank surface may have a convex cross section with a first load flank radius, in particular, when seen from a tangential direction with respect to the longitudinal axis of the pin and/or the box. On the contrary, the internal male load flank surface and the internal female load flank surface may have a concave cross section with a second load flank radius, in particular, when seen from a tangential direction with respect to the longitudinal axis of the pin and/or the box.

The central (male and/or female) load flank surface may comprise, in particular, when seen from a tangential direction with respect to the longitudinal axis of the pin and/or box, a linear surface, or may be rectilinear. More in particular, the central load flank surface starts where the load flank changes from the curved surface of the external load flank surface to a linear surface, and the central load flank surface ends where the load flank changes from the linear surface of the central load flank surface to the curved surface of the internal load flank surface. The central male load flank surface, and the central female load flank surface may extend under an angle of 2-9 degrees, in particular, 5 degrees, with respect to a plane perpendicular to the longitudinal axis of the pin, and box, respectively. A relatively large central load flank surface may provide improved tension resistance, while the benefits relating to the first and second stage are maintained.

The load flank has a (total) load flank height. As such, the male load flank may have a (total) male load flank height, and the female load flank may have a (total) female load flank height. The load flank height is equal to the radial distance between the crest and the root adjacent the load flank. The load flank height may be measured closer to the load flank than to the stab flank. In particular, the load flank height may be defined by the external load flank surface, the central load flank surface, and the internal load flank surface.

The stab flank height and the load flank height may be constant along the axial direction. As such, the stab flank height and the load flank height may have a single stab flank height, and single load flank height, respectively. For example, the stab flank height (or load flank height) of a thread turn of the thread profile located closer to the free end of the pin or box may be the same as the stab flank height (or load flank height) of a thread turn of the thread profile further away from the free end of the pin or box.

The (first) longitudinal axis of the first tubular member, the pin, and the male tapered thread, is the same. Similarly, the (second) longitudinal axis of the second tubular member, the box, and the female tapered thread, is the same. The thread turns of the thread profile may extend helically around the first and/or second longitudinal axis. In particular, the thread turns for the pin may extend helically around the longitudinal axis of the pin, and the thread turns for the box may extend helically around the longitudinal axis of the box.

Within the context of the present disclosure, the term “radial” may mean: perpendicular with respect to the longitudinal axis. As such, the terms “in radial direction”, may mean: in a direction perpendicular with respect to the longitudinal axis.

Within the context of the present disclosure, the term “axial” may mean: in line with the longitudinal axis. As such, the terms “in axial direction”, may mean: in a direction in line with the longitudinal axis.

Parameters (e.g. the first stab flank radius, the second stab flank radius, the first contact angle, the second contact angle, etc.) as described in the present disclosure may be measured in the longitudinal section of a threaded connection.

Within the context of the present disclosure, the thread profile in accordance with the present invention may comprise one or more of the features mentioned in relation with the (male/female) tapered thread of the threaded connection.

Embodiments in accordance with the first, a second, a third, a fourth, and a fifth aspect of the present invention are described in the following.

In an embodiment in accordance with the first aspect of the present invention, the stab flank collision surface is convex in cross section, in particular when seen in tangential direction with respect to the longitudinal axis. In particular, the stab flank collision surface is convex in cross section from a (substantially axially extending) linear surface of the crest up to a (substantially) radially extending part of the stab flank.

In an embodiment in accordance with the first aspect of the present invention, the thread turns are free from a chamfered or bevelled edge between the crest and the stab flank. In particular, the stab flank, more in particular the stab flank collision surface, is free from a chamfered or bevelled edge near the crest. Even more in particular, the male stab flank is free from a chamfered or bevelled edge near the male crest, and the female stab flank is free from a chamfer near the female crest.

In an embodiment in accordance with the first aspect of the present invention, the thread turns comply with:

$$0.2 \leq \frac{{SFR}_{1}}{SFH} \leq 0.34 . \qquad ( 3 )$$

In an embodiment in accordance with the first aspect of the present invention, the thread turns comply with:

$$\frac{{SFR}_{1}}{SFH} = 0.3 . \qquad ( 4 )$$

An advantage of the above embodiments complying with expression (3) and/or (4) is, that, at the second stage of make-up, the risk to galling may be further reduced. In particular, there may be a low maximum (or peak) contact pressure, which will be described in more detail below.

In an embodiment in accordance with the first aspect of the present invention, the stab flank collision surface has a (radial) stab flank collision height, and the thread turns comply with:

$$SFCH = SFH - LFH , \qquad ( 5 )$$

wherein SFCH is the stab flank collision height.

In an embodiment in accordance with the first aspect of the present invention, the thread turns comply with:

$$0.3 mm \leq {SFR}_{1} \leq 0.61 mm . \qquad ( 6 )$$

In an embodiment in accordance with the first aspect of the present invention, the thread turns comply with:

$$0.3 mm \leq {SFR}_{1} \leq 0.51 mm . \qquad ( 7 )$$

In an embodiment in accordance with the first aspect of the present invention, the thread turns comply with:

$${SFR}_{1} = 0.46 mm . \qquad ( 8 )$$

In an embodiment in accordance with the first aspect of the present invention, the thread turns further comply with:

$$1.22 mm \leq SFH \leq 2.29 m . \qquad ( 9 )$$

In an embodiment in accordance with the first aspect of the present invention, the thread turns further comply with:

$$SFH = 1.53 mm . \qquad ( 10 )$$

In an embodiment in accordance with the first aspect of the present invention, the difference between the (male) first stab flank radius of the (male) stab flank collision surface of the at least one thread turn for the pin and the (female) first stab flank radius of the (female) stab flank collision surface of the at least one thread turn for the box is less than 10%.

In an embodiment in accordance with the first aspect of the present invention, the (male) first stab flank radius of the (male) stab flank collision surface of the at least one thread turn for the pin and the (female) first stab flank radius of the (female) stab flank collision surface of the at least one thread turn for the box are equal to each other.

In an embodiment in accordance with the first aspect of the present invention, the stab flank of the thread turns is a perpendicular stab flank (i.e. a stab flank extending substantially perpendicular with respect to the longitudinal axis) or a negatively inclined stab flank. In particular, the stab flanks may extend at a stab flank angle of (−)10 to 0 degrees. This stab flank angle is formed between the stab flank and a plane extending perpendicular with respect to the longitudinal axis of the pin and/or the box.

The present invention is particularly relevant for connections having a thread profile with perpendicular stab flanks or, more in particular, negative stab flanks. Upon collision in the first stage of make-up, these type of stab flanks are more prone to get stuck against each other rather than moving past each other in axial direction as opposed to thread turns employing positive stab flanks.

In an embodiment in accordance with the first aspect of the present invention, the load flank of the thread turns is a perpendicular load flank or a negatively inclined load flank, in particular, when seen in tangential direction with respect to the longitudinal axis of the pin and/or box. In particular, the load flanks may extend at a load flank angle of (−)10 to 0 degrees. The load flank angle is formed between the load flank and a plane extending perpendicular with respect to the longitudinal axis of the pin and/or the box.

As is convention in the art, a negatively inclined flank is one which tends to increase the axial width of the crest of the thread turn as compared with the base of the thread turn. When both the stab flank and the load flank are positively inclined, the thread turn has a narrower crest than base in cross-section. When the load flank is negatively inclined and the stab flank is positively inclined, the thread is a hooked thread. When both the stab flank and the load flank are negatively inclined, the thread turn comprises a dovetail shaped cross-section.

In an embodiment in accordance with the first aspect of the present invention, the thread profile comprises a dovetail shaped cross section, in particular, when seen in tangential direction with respect to the longitudinal axis of the pin and/or box.

In an embodiment in accordance with the first aspect of the present invention, the at least one helically extending thread turn for said pin has an axial thread width decreasing in axial direction towards the free end of the pin, and the at least one helically extending thread turn for said box has an axial thread width decreasing in axial direction towards the free end of the box. In particular, the axial distance between the thread turns of the pin decreases is axial direction from the free end of the pin towards the tubular member comprising the pin, and the axial distance between the thread turns of the box decreases in axial direction from the free end of the box towards the tubular member comprising the box. More in particular, at the end of the second stage of make-up, the stab flanks are in contact with each other and/or the load flanks are in contact, wherein the final make-up position is reached based on interference at the stab flanks and interference at the load flanks.

In such embodiment, the stab flanks may carry a substantial portion of axial compression loads applied to the connection during the exploration and production of a hydrocarbon well. As will be explained below, the inventors found that the above embodiment works particularly well together with an embodiment having a thread profile complying with expression (3), or (4), above. A threaded connection employing such thread profile can have, in addition to the above-described advantages, good resistance to axial compression, regardless of the wall thickness of the tubular members.

In an embodiment in accordance with the first aspect of the present invention, said thread turns have a root, and said stab flank comprises a stab flank internal surface, said stab flank internal surface having a concave cross section, in particular when seen in tangential direction with respect to the longitudinal axis of the pin and/or box, with a second stab flank radius, wherein the thread turns further comply with:

$$0.2 \leq \frac{{SFR}_{2}}{SFH} \leq 0.4 , \qquad ( 11 )$$

wherein SFR₂ is the second stab flank radius.

In an embodiment in accordance with the first aspect of the present invention, the thread turns further comply with:

$${SFR}_{1} = {SFR}_{2} . \qquad ( 12 )$$

As such, the first stab flank radius is equal to the second stab flank radius.

In an embodiment in accordance with the first aspect of the present invention, the thread profile comprises a plurality of helically extending thread turns for said pin, and a plurality of helically extending thread turns for said box. In particular, said plurality of helically extending thread turns for said pin are located adjacent to each other, and said plurality of helically extending thread turn for said box are located adjacent to each other.

In an embodiment in accordance with the first aspect of the present invention, the thread turns for the pin are primary pin thread turns, and the thread turns for the box are primary box thread turns, wherein the thread profile further comprises a plurality of secondary thread turns for the pin, and a plurality of secondary thread turns for the box, the primary thread turns for the pin and secondary thread turns for the pin together forming a helical length of thread for the pin, the primary thread turns for the box and the secondary thread turns for the box together forming a helical length of thread for the box, wherein the primary thread turns for the pin are provided in at least 50%, in particular in at least 80%, of the helical length of thread for the pin, and the primary thread turns for the box are provided in at least 50%, in particular in at least 80%, of the helical length of thread for the box.

In the above embodiment, the primary and secondary helically extending pin thread turns together form a (first) helical length of pin thread, and the primary helically extending primary and secondary box thread turns together form a (second) helical length of box thread. The primary thread turns for the pin are adapted to rotationally engage with the primary thread turns for the box, and the secondary thread turns for the pin may be adapted to rotationally engage with the secondary thread turns for the box.

In an embodiment in accordance with the first aspect of the present invention, said primary helically extending thread turns are located, in axial direction, closer to the free end of the pin than said secondary helically extending thread turns. In particular, the primary helically extending thread turns start near the free end of the pin and extend up to a (n axial) mid-section of the pin thread. In this embodiment, the primary box thread turns may be located, in axial direction, further away from the free end of the box than the secondary helically extending box thread turns. In particular, the primary box thread turns start near a tubular member body side and extend up to a (n axial) mid-section of the box thread.

In an embodiment in accordance with the first aspect of the present invention, the primary pin thread turns are adapted for colliding with the primary box thread turns, free from contact with the secondary thread turns.

In an embodiment in accordance with the first aspect of the present invention, the secondary thread turns for the pin are configured to avoid collision with the primary thread turns of the box. In addition, the secondary thread turns for the box may be configured to avoid collision with the primary thread turns for the pin.

In an embodiment in accordance with the first aspect of the present invention, the secondary thread turns for the pin are configured to avoid collision with the secondary thread turns for the box, in particular during the first stage of make-up.

For example, the secondary thread turns may have a stab flank height that is smaller than the stab flank height of the primary thread turns. In particular, the secondary thread turns of the box may have a smaller stab flank height than the secondary thread turns of the pin.

In the above embodiments having both primary as well as secondary thread turns, the first stage of make-up may be mainly governed by the primary thread turns, wherein the primary thread turns help to align the pin with respect to the box, wherein cross threading may be prevented. As such, merely a small part of the entire thread profile may comprise features to promote easy stabbing. This way, fewer machining steps may be required to produce the thread profile.

In an embodiment in accordance with the first aspect of the present invention, the crests of the thread turns are parallel to the longitudinal axis.

In an embodiment in accordance with the first aspect of the present invention, the roots of the thread turns are parallel to the longitudinal axis.

In a second aspect of the present invention there is provided a threaded connection for exploration and production of a hydrocarbon well, comprising a pin and a box, wherein the threaded connection comprises a thread profile in accordance with the first aspect of the present invention. In particular, the threaded connection can have a thread profile in accordance with any of the embodiments described in relation with the first aspect.

In a third aspect of the present invention there is provided a pin for a threaded connection for exploration and production of a hydrocarbon well, comprising at least one helically extending thread turn, said at least one thread turn having a stab flank with a stab flank height, a load flank with a load flank height, and a crest, wherein:
said stab flank comprises a stab flank collision surface adjoining the stab flank with the crest;
said stab flank collision surface has a first stab flank radius; and
said thread turns comply with:

$$LFH < SFH , and \qquad ( 1 )$$

$$0.2 \leq \frac{{SFR}_{1}}{SFH} \leq 0.4 , \qquad ( 2 )$$

wherein SFR₁ is the first stab flank radius, SFH is the stab flank height, and LFH is the load flank height.

In a fourth aspect of the present invention there is provided a box for a threaded connection for exploration and production of a hydrocarbon well, comprising at least one helically extending thread turn, said at least one thread turn having a stab flank with a stab flank height, a load flank with a load flank height, and a crest, wherein:
said stab flank comprises a stab flank collision surface adjoining the stab flank with the crest;
said stab flank collision surface has a first stab flank radius; and
said thread turns comply with:

$$LFH < SFH , and \qquad ( 1 )$$

$$0.2 \leq \frac{{SFR}_{1}}{SFH} \leq 0.4 , \qquad ( 2 )$$

wherein SFR₁ is the first stab flank radius, SFH is the stab flank height, and LFH is the load flank height.

In a fifth aspect of the present invention there is provided a method of forming a threaded connection, comprising the steps of:
providing a pin, and a box, with a thread profile in accordance with the first aspect;
inserting, in a first stage of make-up, said pin into said box; and
rotating, in a second stage of make-up, said pin with respect to said box in a make-up direction.

In an embodiment in accordance with the fifth aspect of the present invention, the step of rotating is performed after reaching, in the step of inserting, a final insertion position. The final insertion position is where the longitudinal axes of the pin and box are aligned, and deeper stabbing is no longer possible.

It will be clear to the skilled person that the second, third, fourth, and fifth aspect of the present disclosure may include features relating to the first aspect of any combination of the above-described embodiments of the first aspect of the present invention.

For a better understanding of the present invention, and to show how the same may be put into effect, reference will now be made, by way of example only, to the accompanying drawings in which:

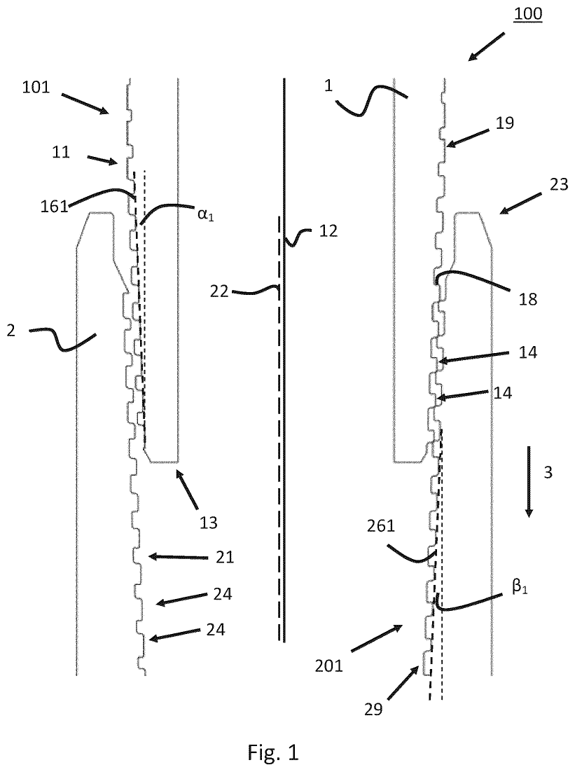

FIG. 1 schematically shows a longitudinal sectional view of a threaded connection in accordance with the present disclosure;

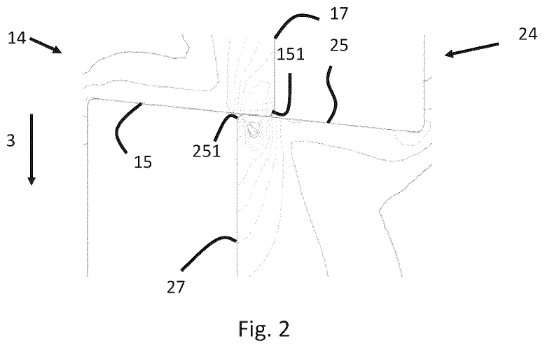

FIG. 2 shows a cross sectional view at a thread turn of a threaded connection of the prior art;

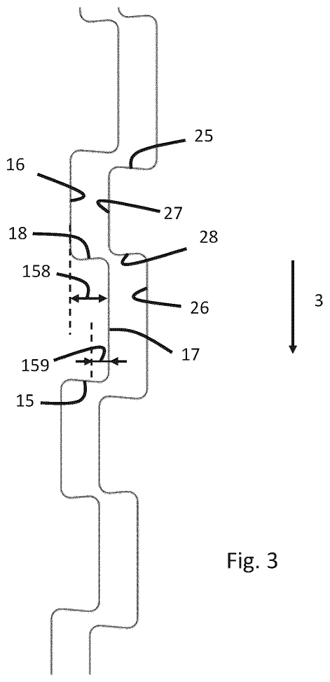

FIG. 3 shows a cross sectional view of a thread profile of a threaded connection in accordance with the present invention;

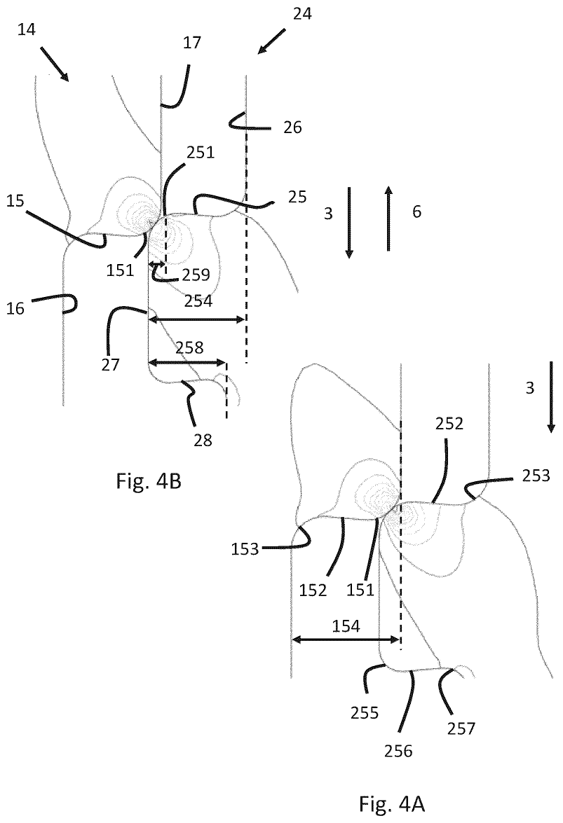

FIGS. 4A and 4B provide a detailed view of the thread turns of a thread profile of a threaded connection in accordance with the present invention;

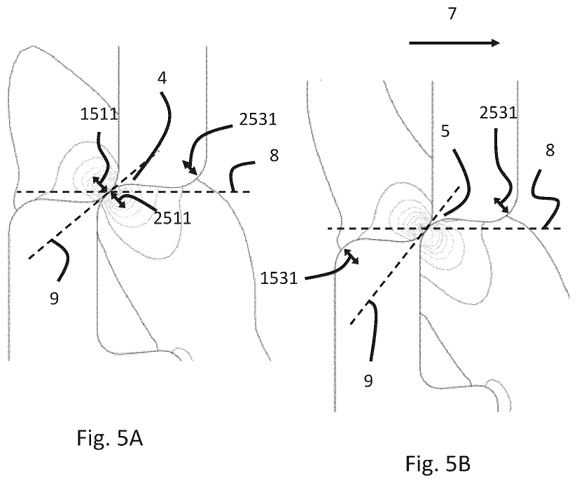

FIG. 5A shows thread turns in accordance with the present invention, wherein a first contact angle is formed;

FIG. 5B shows thread turns in accordance in the present invention, wherein a second contact angle is formed;

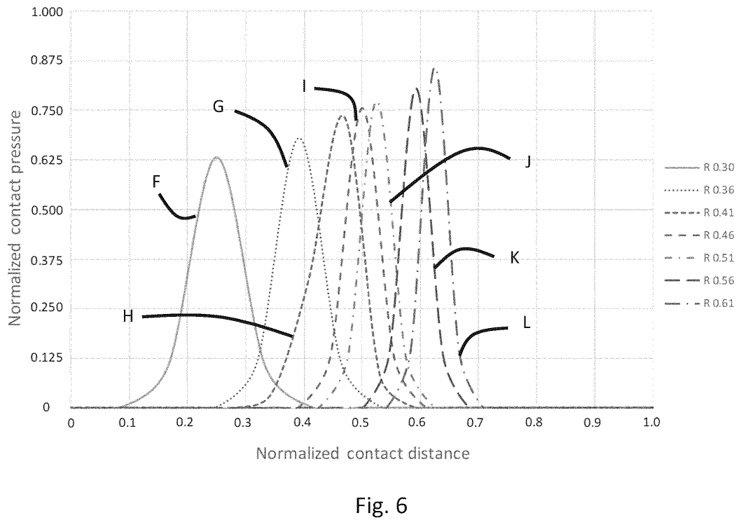

FIG. 6 shows a graph indicating contact pressures at the threads of various samples, in the first stage of make-up; and

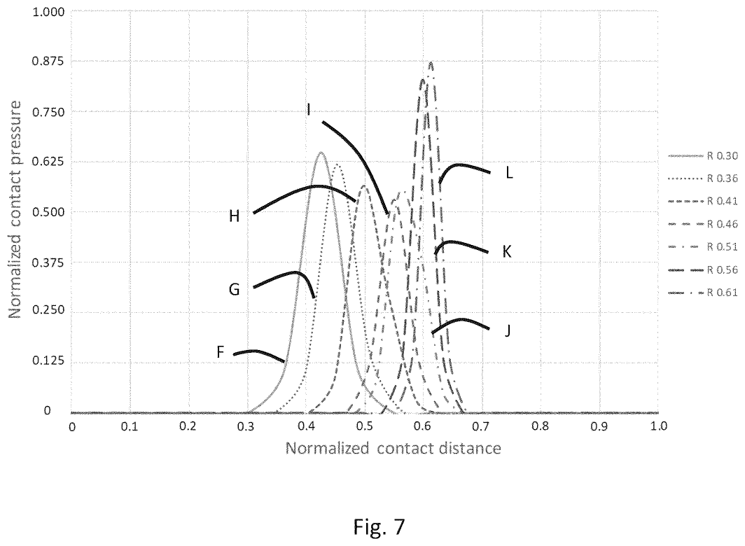

FIG. 7 shows a graph indicating contact pressures at the threads of various samples, in the second stage of make-up.

FIG. 1 shows a longitudinal sectional view of a threaded connection 100 in a first stage of make-up. The threaded connection 100 comprises a pin 1, and a box 2. The pin 1 is part of a first tubular member (not shown), and the box 2 is part of a second tubular member (not shown).

The threaded connection 100 comprises a thread profile 11, 21, comprising a male tapered thread 11 at the outer surface 101 of the pin 1, and a female tapered thread 21 at the inner surface 201 of the box 2.

The male tapered thread 11 comprises a plurality of male thread turns 14. The male tapered thread turns 14 converge helically towards a free end 13 of the pin 1, wherein the outer diameter of the pin 1 decreases towards the free pin end 13 of the pin 1. The female tapered thread 21 comprises a plurality of female thread turns 24. The female tapered thread turns 24 diverge helically towards a free end 23 of the box 2, wherein the inner diameter of the box 2 increases towards the free end 23 of the box 2.

As can be seen in FIG. 1, the pin 1 has a first longitudinal axis 12, and the box 2 has a second longitudinal axis 22. In FIG. 1, the pin 1 is being stabbed into the box 2, wherein the pin 1 is moved in axial direction 3, with respect to the box 2. As shown in FIG. 1, in the first stage of make-up, the first and second longitudinal axes 12, 22 may be offset (i.e. misaligned) with respect to each other.

The male tapered thread 11 comprises a male root 16, a male crest 17, a male load flank 18, and a male stab flank 15. The male root 16 extends along a male root taper angle α1 with respect to the longitudinal axis 12 of the pin 1. The male root taper has a single male root taper angle α1. As such, the male root 16 extends along a constant conical male root generatrix 161. The male crest 17 extends along a male crest taper angle which angle is equal to the male root taper angle α1. As such, the male crest also extends along a constant conical male crest generatrix (not shown). The conical male root generatrix 161 and the conical male crest generatrix extend in the same direction. The conical male root generatrix 161 is closer to the longitudinal axis 12 of the pin 1 than the conical male crest generatrix.

The female tapered thread 21 extends helically along the inner surface 201 of the box 2. The female tapered thread 21 comprises a female root 26, a female crest 27, a female load flank 28, and a female stab flank 25. The female stab flank 25 corresponds with the male stab flank 15. The female root 26 extends along a single female root taper angle β1 with respect to the longitudinal axis 22 of the box 2. As such, the female root 26 extends along a constant conical female root generatrix 261. The female crest 27 extends along a female crest taper angle (not shown) that is equal to the female root taper angle β1. As such, the female crest 27 also extends along a constant conical female crest generatrix. The conical female root generatrix 261 and the conical female crest generatrix extend in parallel with respect to each other. The conical female root generatrix 261 is located further away from the longitudinal axis 22 of the box 2 than the conical female crest generatrix.

The male crest 17 and the male root 16 are parallel to the longitudinal axis 11 of the pin 1. The female crest 27 and the female root 26 are parallel to the longitudinal axis 21 of the box 2.

The male stab flank 15 of each turn 14 faces towards the free end of the pin 13. The male load flank 25 faces away from the free end 13 of the pin 1. Similarly, the female stab flank 25 faces towards the free end 23 of the box 2. The female load flank 28 faces away from the free end 23 of the box 2.

The stab flanks 15, 25 comprise a stab flank collision surface 151, 251, a central stab flank surface 152, 252, and an internal stab flank surface 153, 253. The stab flank collision surfaces 151, 251 have a rounded cross section with a first stab flank radius 1511, 2511, in particular when seen in tangential direction with respect to the longitudinal axis. The internal stab flank surfaces 153, 253 have a rounded cross section with a second stab flank radius 1531, 2531, in particular when seen in tangential direction with respect to the longitudinal axis. The stab flank collision surfaces 151, 251 are convex, following a circular arc. The internal stab flank surfaces 153, 253 are concave, following a circular arc. The first stab flank radius 1511, 2511 is the same as the second stab flank radius 1531, 2531.

The stab flank 15, 25 has a stab flank height 154, 254. The load flank 18, 28 has a load flank height 158, 258. The stab flank height 154, 254 and the load flank height 158, 258 are constant along the axial direction 3. The load flank height 158, 258 is smaller than the stab flank height 154, 254.

The stab flank collision surface 151, 251 has a radial stab flank collision height 159, 259. The stab flank collision height is equal to the difference between the stab flank height and the load flank height. The male stab flank collision surface 151 is adapted to contact the female stab flank collision surface 251 in the first stage of make-up.

It should be noted that, the stab flank collision height 159, 259 relates to a radial distance within which collision between the stab flank collision surfaces 152, 251 may occur. The stab flank collision height is not necessarily the radial distance over which the entire stab flank collision surface extends. The stab flank collision surface may extend over a larger radial distance than the stab flank collision height. In particular, the stab flank collision surface stops where the central stab flank surface starts, which is where the surface of the stab flank does no longer follow a circular arc but follows a linear surface.

The tapered pin thread 11 and the tapered box thread 21 have a dovetail shaped cross section. In particular, thread turns 14, 24 are in axial direction 3 wider at the crest 17, 27 than at the root 16, 26. More in particular, the thread turns 14, 24 are, in axial direction, wider at the stab flank collision surface 151, 251 than at the central stab flank surface 152, 252. Further, the tapered pin thread 11 has an axial thread width decreasing in axial direction 3 towards the free end 13 of the pin 1. The tapered female thread 21 has a corresponding axial thread width decreasing in the opposite axial direction 6 towards the free end 23 of the box 2. As such, the threaded connection 100 comprises threads 11, 21 having a varying width in axial direction 3. The axial space between the thread turns 14, 24 increases from the tubular member towards the free end 13, 23 of the pin 1, and box 2, respectively. In particular, the threads 11, 21 have a load flank lead, and a stab flank lead, wherein there is a difference between the load flank lead and the stab flank lead. In particular, the load flank lead may be greater than the stab flank lead. Both the load flank lead and the stab flank lead may be constant.

All thread turns 14, 24 have a stab flank collision surface 151, 251 with the same first stab flank radius 1511, 2511. As can been seen in FIG. 1, the threaded connection 100 is free from obstructions in the vicinity of the threads 11, 21. In particular, as the threads have a varying axial width, the threaded connection can be made up in the second stage of make-up based on interference at the stab flanks 15, 25 and based on interference at the load flanks 18, 28, instead of requiring the box 2 to have a box stop shoulder wherein the final make-up position of the connection is achieved by means of an intermediate shoulder of the pin or the free end 13 of the pin 1 contacting a corresponding stop shoulder of the box. In particular, the threaded connection 100 is free from a box stop shoulder that may obstruct stabbing of the pin 1 into the box 2 in the first stage of make-up.

FIG. 2 shows a cross sectional view at a thread turn 14, 24 of a threaded connection of the prior art in the first stage of make-up. The thread turn 14, 24 comprises a stab flank 15, 25, a crest 17, 27, and a stab flank collision surface 151, 251 adjoining the crest 17, 27 with the stab flank 15, 25. The stab flank collision surfaces 151, 251 both have a cross section with a relatively small radius. As shown in FIG. 2, the stab flanks contact each other, wherein the male stab flank 15 is inclined to move in radial direction with respect to the female stab flank 25, wherein the male crest 17 is inclined to move towards the female root 26. In addition, it can be seen in FIG. 2 that forces as a result of contact between the stab flanks 15, 25 are concentrated near the crest of the thread turn 14, 24, wherein reaction forces are mainly directed in axial direction 3. As such, a relatively small portion of the stab flank 15, 25 must be arranged to sustain these forces in order to prevent damage to the threads 11, 21.

Different from FIG. 2, the thread profile of FIGS. 3-5B comprises a stab flank collision surface 151, 251 with a circular arced cross section having a relatively large radius. In particular, the first stab flank radius 1511, 2511 is 0.46 mm. The first stab flank radius 1511 is selected such to, in the first stage of make-up as shown in FIG. 5A, help the stab flanks 15, 25 to easily pass each other in axial direction 3, while at the same time making sure that, in the second stage of make-up as shown in FIG. 5B, the male stab flank 15 does not extend too far beyond the female stab flank 25 in axial direction 3. As such, the sliding distance, in axial direction 6 and radial direction 7, that the stab flanks 15, 25 slide against each other in the second stage of make-up is relatively short.

In the first stage of make-up, a first contact angle 4 is formed at the stab flank collision surfaces 151, 251. As shown in FIG. 5A, the first contact angle 4 is formed between a line 9 tangent to where the stab flank collision surfaces 151, 251 collide, and a line 8, which line 8 lies in a plane perpendicular to the longitudinal axis 22. The first contact angle 4 is about 42 degrees. The first contact angle is taken where there is maximum radial misalignment of the pin 1 with respect to the box 2.

In FIGS. 3, 4A, and 5A, the longitudinal axis 12 of the pin 1 is parallel, but not coaxial, with the longitudinal axis 22 of the box 2. As the threads 11, 21 are tapered, wherein the crests 17, 27 extend along a constant conical generatrix 161, 261, and the stab flank height 154, 254 is greater than the load flank height 158, 258, the female crest 27 forms a radial boundary for the male crest 17. In particular, the crests 17, 27 extend in parallel with the longitudinal axis 12, 22, respectively.

At the start of the second stage of make-up, the male stab flank 15 is located further in the box 2 than the corresponding female stab flank 25. The male stab flank 15 is seated against the female stab flank 25. Here, a second contact angle 5 is formed at the stab flank collision surfaces 151, 251. In this case, the longitudinal axis 12, 22 are coaxial. The second contact angle 5 is formed between a line 9 tangent to where the stab flank collision surfaces 151, 251 touch and line 8. The second contact angle 5 is larger than the first contact angle 4. In particular, the second contact angle 5 is about 51 degrees.

The first contact angle, and the second contact angle, may be measured in the longitudinal section of the connection 100.

Further, as shown in FIGS. 4A, and 4B, the contact pressures are formed mainly at the center of the stab flank collision surfaces 151, 251, wherein reaction forces extend through the thread turns 14, 24 mainly in axial and radial direction. In particular, the contact pressures are equally distributed over the stab flank collision surfaces 151, 251. In particular, forces as a result of contact between the collision surfaces 151, 251 are distributed more evenly through thread turns 14, 24 than in the example shown in FIG. 2.

Importantly, the first stab flank radius 2511 should not be chosen such that upon contact between surfaces 151, 251, the first contact angle 4 is too large, because this may negatively affect the second contact angle 5 causing that the second contact angle 5 is also too large, which would increase the sliding distance in the second stage of make-up. In addition, it is understood that having a larger first contact angle 4 would also negatively affect contact pressures in the second stage of make-up.

As shown in FIG. 1, the thread profile 11, 21 of the threaded connection 100 may have secondary thread turns 19, 29, namely secondary pin thread turns 19, and secondary box thread turns 29. The secondary pin thread turns 19 are located at a second axial distance from the free end 13 of the pin. The primary pin thread turns 14 are located at a first axial distance from the free end 13 of the pin. Similarly, the secondary box thread turns 29 are located at a second axial distance from the free end 23 of the box. The primary box thread turns 24 are located at a first axial distance from the free end 23 of the box. The second axial distance is greater than the first axial distance. The stab flank height 154 of the secondary pin thread turns 19 is smaller than the stab flank height 254 of the secondary box thread turns 29.

Fourteen different thread profile examples, namely: A-N, have been analysed to optimize the stab flank of a threaded connection 100. In Table 1 below, results of the analysis are presented.

TABLE 1

| | | | | Acceptable | | | | |
|---|---|---|---|---|---|---|---|---|
| | | | | distribution | | Stab | | |
| | | First contact | Second contact | of contact | Force | Flank | Central | |
| | Radii | angle in 1^{st} | angle in 2^{nd} | pressure | applied | Angle | SFH/ | SFR₁/ |
| Example | [mm] | Stage [Deg) | stage [Deg) | [Y/N] | [ton] | [Deg] | LFH | SFH |
| A | 0.05 | NaN | NaN | N | 1.5 | 5 | 254% | 3.3% |
| B | 0.10 | NaN | 0.00 | N | 1.5 | 5 | 234% | 6.7% |
| C | 0.15 | 0 | 19.47 | N | 1.5 | 5 | 214% | 10.0% |
| D | 0.20 | 14.48 | 30.00 | N | 1.5 | 5 | 194% | 13.3% |
| E | 0.25 | 23.58 | 36.87 | N | 1.5 | 5 | 175% | 16.7% |
| F | 0.30 | 30 | 41.81 | Y | 1.5 | 5 | 155% | 20.0% |
| G | 0.36 | 34.85 | 45.58 | Y | 1.5 | 5 | 135% | 23.3% |
| H | 0.41 | 38.68 | 48.59 | Y | 1.5 | 5 | 115% | 26.7% |
| I | 0.46 | 41.81 | 51.03 | Y | 1.5 | 5 | 95% | 30.0% |
| J | 0.51 | 44.43 | 53.53 | Y | 1.5 | 5 | 75% | 33.3% |
| K | 0.56 | 46.66 | 54.90 | Y | 1.5 | 5 | 56% | 36.7% |
| L | 0.61 | 48.59 | 56.44 | Y | 1.5 | 5 | 36% | 40.0% |
| M | 0.66 | 50.28 | 57.80 | N | 1.5 | 5 | 16% | 43.3% |
| N | 0.69 | 51.06 | 58.41 | N | 1.5 | 5 | 6% | 45.0% |

The examples have a first stab flank radius ranging from 0.05 to 0.69 mm. Each of the examples employs a constant thread taper angle of 2.33 degrees. Further, in the analyses, a compression force to the pin of 1.5 ton was applied to each of the examples. This weight corresponds to the general weight of two to three stacked tubular members which are inserted into a box 2 at a wellbore. Further, in all of the examples, the first stab flank radius is equal to the second stab flank radius.

In particular, the examples relate to a thread profile having a negative (central) stab flank of 5 degrees, and a negative (central) load flank. In the examples, the load flank lead is greater than the stab flank lead. As such, the axial thread width of the thread turns decrease in axial direction towards the free end of the pin and box. Further, the axial distance between the thread turns decreases is axial direction from the free end towards the tubular member comprising the pin and box. At the end of the second stage of make-up, the stab flanks are in contact with each other and/or the load flanks are in contact, wherein the final make-up position is achieved based on flank to flank interference. In particular, the tested examples are free from a final make-up shoulder.

In threaded connections wherein the final make-up position is achieved based on stab flank, and load flank, interference, compression and tension resistance needs to be provided by means of the threads. In particular, resistance to compression loads is mainly provided by the stab flanks, and resistance to tension loads is mainly provided by the load flanks. For compression resistance, a large central stab flank surface over load flank height ratio is beneficial, because the compression resistance relies on the size of the total surface of the thread that supports against compression loads. A central stab flank surface height over load flank height of 100% is considered to indicate a resistance against compression loads that is about equal to resistance against tension loads.

In view of the above, Table 1 also includes per example an indication of the compression resistance at final make-up. A connection with a higher compression resistance is considered better than a connection having a lower compression resistance. In this regard, it should be appreciated, that increasing first stab flank radius generally comes with a concession to the size of the central stab flank surface.

As shown by Table 1, the central stab flank height over load flank height ratio of the examples reduces as the radius of the stab flank collision surface is increased.

In Table 1, examples A-E and M-N relate to thread profiles leading to a relatively un-centered distribution of contact pressures. With this is meant, that the contact pressures are mainly located away from the center of the stab flank collision surface.

As can be seen in Table 1, the first and second contact angles of examples A-E are lower than those of examples F-N. The greater the first contact angle, the more likely it is that colliding stab flank surfaces can pass each other during the first stage of make-up. The lower the first contact angle, the greater the risk that the connection gets stuck in the first stage of make-up.

Examples F-N exhibit good stabability with respect to examples A-E. As it turns out, a first contact angle of 30 degrees or greater is enough to have smooth stabbing in the first stage of make-up.

FIG. 6 shows a graph indicating the normalized contact pressure over normalized contact distance for various examples of thread profiles, in the first stage of make-up. FIG. 7 shows a graph indicating the normalized contact pressure over normalized contact distance for various examples of thread profiles, in the second stage of make-up.

In both FIGS. 6 and 7, the center of the X-axis represents the center of the stab flank collision surfaces. It follows that the greater the first stab flank radius, the greater the first contact angle. As such, example L exhibits better stabability than example K, example K exhibits better stabability than example J, and so on.

A greater first contact angle allows easier stabbing. On the other hand, a greater first contact angle also tends to cause a greater sliding distance in the second stage of make-up.

In FIG. 7, graphs skewed to the right tend to require a larger sliding distance in the second stage of make up to reach the final make up position.

FIG. 6 shows the contact pressure distribution of examples F-L in the first stage of make-up. From FIG. 6, it follows that peak contact pressure increases throughout examples F to L. For a thread profile with a first stab flank radius of 0.41 mm to 0.56 (being examples H-K) the contact pressure of these examples is relatively evenly distributed over the contact distance at the center of the first stab flank collision surface. On the other hand, the contact pressure distribution of examples F and G, with a first stab flank radius of 0.30 mm, and 0.36 mm, respectively, is skewed to the left along the X-axis.

Of the examples shown in FIG. 6, namely: examples F-L, example 1 shows the most centered contact pressure distribution. Further, example 1 has a lower peak contact pressure than examples J-L.

In FIG. 7 it can be seen, that in examples K and L a relatively high peak contact pressure is developed during the second stage of make-up as compared to examples F-J. High peak contact pressures over a short distance may lead to damage to the threads. Further, of the examples F-J, peak contact pressure tends to go down as the first stab flank radius increases. In particular, example I exhibits a centralized contact pressure distribution, with the lowest peak in contact pressure.

When comparing the graphs of FIGS. 6 and 7, one can see that examples G, H, I, and J, perform well in the first stage of make-up as well as in the second stage of make-up. In particular, examples G, H, I, and J, exhibit a centralized contact pressure distribution in both stages of make up, as well as a relatively low peak contact pressure in the second stage of make up. Examples H, I, and J, exhibit in the first stage of make-up, and in the second stage of make-up, an even more centralized contact pressure distribution and a relatively small sliding distance. More in particular, example I performs well in the first stage of make-up, and exhibits the lowest peak contact pressure in the second stage of make-up.

Examples I-H further result in a thread profile with good compression resistance.

As required, detailed embodiments of the present invention have been disclosed in the figures. However, it is to be understood that the disclosed embodiments are merely exemplary, wherein invention can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In particular, the thread profile, or the threaded connection, in accordance with the present invention may comprise a so-called “run-in” and/or “run-out” at one or both of the axial thread ends. Further, it is anticipated, that the threads of the thread profile, or threaded connection, in accordance with the present invention can comprise a crest to root clearance. Further, it is anticipated, that, in the thread profile in accordance with the present invention, the first stab flank radius may be equal to the second stab flank radius, and/or wherein the crest of one or more thread turns has a reduced height (e.g. by means of a conical or cylindrical cut).

The terms “a” or “an”, as used herein, are defined as one or more than one. The terms multitude or plurality, as used herein, is defined as two or more than two. The term another, as used herein, is defined as at least a second or more. The terms including and/or having as used herein, are defined as comprising (i.e., open language, not excluding other elements or steps). Any reference signs in the claims should not be construed as limiting the scope of the claims or the invention.

It will be apparent to those skilled in the art that various modifications can be made to the shown thread profile and threaded connection according to the invention without departing from the scope as defined in the claims.

1. A thread profile for a pin and a box of a threaded connection for exploration and production of a hydrocarbon well, comprising at least one helically extending thread turn for said pin, and at least one helically extending thread turn for said box, said thread turns having a stab flank with a stab flank height, a load flank with a load flank height, and a crest, wherein:
said stab flank comprises a stab flank collision surface adjoining the stab flank with the crest;
said stab flank collision surface has a first stab flank radius; and
said thread turns comply with:
$$LFH < SFH , and \qquad ( 1 )$$
$$0.2 \leq \frac{{SFR}_{1}}{SFH} \leq 0.4 , \qquad ( 2 )$$
wherein SFR₁ is the first stab flank radius, SFH is the stab flank height, and LFH is the load flank height.

2. The thread profile of claim 1, wherein said thread turns comply with:
$$0.2 \leq \frac{{SFR}_{1}}{SFH} \leq 0.34 . \qquad ( 3 )$$

3. The thread profile of claim 1, wherein said thread turns comply with:
$$\frac{{SFR}_{1}}{SFH} = 0.3 . \qquad ( 4 )$$

4. The thread profile of claim 1, wherein the stab flank collision surface has a stab flank collision height, and the thread turns comply with:
$$SFCH = SFH - LFH , \qquad ( 5 )$$
wherein SFCH is the stab flank collision height.

5. The thread profile of claim 1, wherein the thread turns comply with:
$$0.3 mm \leq {SFR}_{1} \leq 0.61 mm , \qquad ( 6 )$$

6. The thread profile of claim 1, wherein the thread turns further comply with:
$$1.22 mm \leq SFH \leq 2.29 mm [ [ , ] ] . \qquad ( 9 )$$

7. The thread profile of claim 1, wherein the difference between the first stab flank radius of the stab flank collision surface of the at least one thread turn for the pin and the first stab flank radius of the stab flank collision surface of the at least one thread turn for the box is less than 10%.

8. The thread profile of claim 1, the stab flank of the thread turns is a perpendicular stab flank or a negatively inclined stab flank.

9. The thread profile of claim 1, wherein said thread turns comprise a dovetail shaped cross section.

10. The thread profile of claim 1, wherein the at least one helically extending thread turn for said pin has an axial thread width decreasing in axial direction towards the free end of the pin, and the at least one helically extending thread turn for said box has an axial thread width decreasing in axial direction towards the free end of the box.

11. The thread profile of claim 1, said thread turns having a root, and said stab flank comprising a stab flank internal surface, said stab flank internal surface having a second stab flank radius, wherein the thread turns further comply with:
$$0.2 \leq \frac{{SFR}_{2}}{SFH} \leq 0.4 , \qquad ( 11 )$$
wherein SFR₂ is the second stab flank radius.

12. The thread profile of claim 11, wherein:
$${SFR}_{1} = {SFR}_{2} . \qquad ( 12 )$$

13. The thread profile of claim 1, wherein the thread turns for the pin are primary pin thread turns, and the thread turns for the box are primary box thread turns, and wherein the thread profile further comprises a plurality of secondary thread turns for the pin, and a plurality of secondary thread turns for the box, the primary thread turns for the pin and secondary thread turns for the pin together forming a helical length of thread for the pin, the primary thread turns for the box and the secondary thread turns for the box together forming a helical length of thread for the box, wherein the primary thread turns for the pin are provided in at least 50%, of the helical length of thread for the pin, and the primary thread turns for the box are provided in at least 50% of the helical length of thread for the box.

14. The thread profile of claim 13, wherein said primary helically extending thread turns are located, in axial direction, closer to the free end of the pin than said secondary helically extending thread turns.

15. The thread profile of claim 13, the primary pin thread turns are adapted for colliding with the primary box thread turns, free from contact with the secondary thread turns.

16. The thread profile of claim 13, wherein the secondary thread turns for the pin are configured to avoid collision with the secondary thread turns for the box.

17. The thread profile of claim 1, wherein the crests of the thread turns are parallel to a longitudinal axis of the helically extending thread turns.

18. A threaded connection for exploration and production of a hydrocarbon well, comprising a pin and a box, wherein the threaded connection comprises a thread profile of claim 1.

19. A pin for a threaded connection for exploration and production of a hydrocarbon well, comprising at least one helically extending thread turn, said at least one thread turn having a stab flank with a stab flank height, a load flank with a load flank height, and a crest, wherein:
said stab flank comprises a stab flank collision surface adjoining the stab flank with the crest;
said stab flank collision surface has a first stab flank radius; and
said thread turns comply with:
$$LFH < SFH , and \qquad ( 1 )$$
$$0.2 \leq \frac{{SFR}_{1}}{SFH} \leq 0.4 , \qquad ( 2 )$$
wherein SFR₁ is the first stab flank radius, SFH is the stab flank height, and LFH is the load flank height.

20. A box for a threaded connection for exploration and production of a hydrocarbon well, comprising at least one helically extending thread turn, said at least one thread turn having a stab flank with a stab flank height, a load flank with a load flank height, and a crest, wherein:
said stab flank comprises a stab flank collision surface adjoining the stab flank with the crest;
said stab flank collision surface has a first stab flank radius; and
said thread turns comply with:
$$LFH < SFH , and \qquad ( 1 )$$
$$0.2 \leq \frac{{SFR}_{1}}{SFH} \leq 0.4 , \qquad ( 2 )$$
wherein SFR₁ is the first stab flank radius, SFH is the stab flank height, and LFH is the load flank height.

21. A method of forming a threaded connection, comprising the steps of:
providing a pin and a box with a thread profile of claim 1;
inserting, in a first stage of make-up, said pin into said box; and
rotating, in a second stage of make-up, said pin with respect to said box in a make-up direction.

22. A method of forming a threaded connection of claim 21, wherein the step of rotating is performed after reaching, in the step of inserting, a final insertion position.
